(19) United States
(12) Patent Application Publication
(10) Pub. No.: US 2012/0161037 A1
(43) Pub. Date: Jun. 28, 2012

(54) Dose Measurement Method using Calorimeter

(75) Inventor: Marvin Farley, Ipswich, MA (US)

(73) Assignee: Axcelis Technologies, Inc., Beverly, MA (US)

(21) Appl. No.: 12/977,269

(22) Filed: Dec. 23, 2010

(51) Int. Cl. G21G 5/00

(52) U.S. Cl. 250/492.3

(57) ABSTRACT

An ion implantation system for implanting ions into a workpiece is provided, having a process chamber and an energy source configured to produce a plasma of ions within the process chamber. A workpiece support having a support surface configured to position the workpiece within an interior region of the process chamber is configured to expose an implantation surface of the workpiece to the plasma of ions. A pulse generator is in electrical communication with the workpiece support, wherein the pulse generator is configured to apply an electrical pulse to the support, therein attracting ions to the implantation surface of the workpiece and implanting ions into the workpiece. A calorimeter is further associated with the workpiece support, wherein a controller is configured to monitor a signal from the calorimeter and to control the implantation of ions into the workpiece based, at least in part, on the signal from the calorimeter.

### TECHNICAL FIELD

The present invention relates generally to ion implantation dose measurement systems and methods, and more specifically to an in-situ dose measurement system comprising a calorimeter.

### BACKGROUND

In the semiconductor industry, ions are implanted into a workpiece, such as a semiconductor wafer, in order to provide specific characteristics in the workpiece. Various different systems and methodologies are available for implanting the ions; one of which is a plasma immersion ion implantation (PIII) system. In a PIII system, the workpiece is maintained at a predetermined potential, and the implantation is performed in distinct pulses, wherein a large volume of plasma is pulsed for a very short duration. During the pulse, the ions in the plasma are attracted to the workpiece, therein depleting all the ions in the plasma. The plasma is then switched off, allowed to recharge, and then pulsed again. This process is repetitively performed until a desired amount of ions are implanted into the workpiece.

One of the ongoing problems with a PIII system is the measurement of the implant dose during the implantation, and the associated determination of when the implant should end. When the plasma is pulsed at a relatively high voltage (e.g., 6500V) for a very short duration (e.g., 60 microseconds), the ions in the plasma are accelerated onto the workpiece. In the past, a Faraday cup has been used to measure the dose, however, various shortcomings have been experienced using a Faraday cup to measure the total dose. Another method for measuring the total implant dose is to measure a temperature of a given thermal mass at the beginning of the implant, and measure its temperature at the end of the implant, and then back-calculate the dose using the change in potential energy of the thermal mass. Such a methodology, however, is often adversely affected by various environmental factors, such as radiation loss and conductive loss from electrodes used to make the measurement (e.g., thermocouples, etc.). On low energy implants (e.g., an implant depositing energy on the order of 5 Joules), a relatively low thermal mass is necessitated for such a methodology, thus demanding the thermal resistance to surroundings to be high. Such a scenario is often difficult to achieve. Accordingly, a need exists for a new and more robust measurement system and methodology for measuring dosage of an implantation during implantation.

### SUMMARY

The present invention overcomes the limitations of the prior art by providing a system and method for measuring implant dosage in a plasma emersion implant system utilizing a calorimeter. Accordingly, the following presents a simplified summary of the disclosure in order to provide a basic understanding of some aspects of the invention. This summary is not an extensive overview of the invention. It is intended to neither identify key or critical elements of the invention nor delineate the scope of the invention. Its purpose is to present some concepts of the invention in a simplified form as a prelude to the more detailed description that is presented later.

In accordance with the present disclosure, an ion implantation system for implanting ions into a workpiece is provided. A process chamber is provided having an energy source configured to produce a plasma of ions within the process chamber. A workpiece support having a support surface configured to position the workpiece within an interior region of the process chamber is configured to expose an implantation surface of the workpiece to the plasma of ions. A pulse generator is in electrical communication with the workpiece support, wherein the pulse generator is configured to apply an electrical pulse to the support, therein attracting ions to the implantation surface of the workpiece and implanting ions into the workpiece. A calorimeter is further associated with the workpiece support, wherein a controller is configured to monitor a signal from the calorimeter and to control the implantation of ions into the workpiece based, at least in part, on the signal from the calorimeter.

The calorimeter, in one exemplary aspect, comprises a micro-calorimeter, wherein ion implantation deposition energy is measured directly. The micro-calorimeter, for example, measures the deposition energy of ions transmitted through a known aperture area. In one example, the micro-calorimeter comprises a low mass absorption calorimeter, wherein the calorimeter is designed to dissipate approximately a small amount of energy at a controlled temperature greater than an internal temperature of the process chamber. The electronics, for example, are battery powered and communicate to ground through fiber optic links. The batteries, for example, are recharged during workpiece exchange and vacuum recovery periods.

The above summary is merely intended to give a brief overview of some features of some embodiments of the present invention, and other embodiments may comprise additional and/or different features than the ones mentioned above. In particular, this summary is not to be construed to be limiting the scope of the present application. Thus, to the accomplishment of the foregoing and related ends, the invention comprises the features hereinafter described and particularly pointed out in the claims. The following description and the annexed drawings set forth in detail certain illustrative embodiments of the invention. These embodiments are indicative, however, of a few of the various ways in which the principles of the invention may be employed. Other objects, advantages and novel features of the invention will become apparent from the following detailed description of the invention when considered in conjunction with the drawings.

### BRIEF DESCRIPTION OF THE DRAWINGS

FIG. 1 is a block diagram of an ion implantation system according to several aspects of the present disclosure.

FIG. 2 illustrates a schematic diagram of an ion implantation dose measuring system in accordance with one example of the disclosure.

FIG. 3 illustrates a graph of a modeled control loop of an ion implantation, according to another exemplary aspect.

FIG. 4 illustrates a graph of a measured dosage and calorimeter power versus an input dosage, according to another exemplary aspect.

FIG. 5 illustrates a graph of measurement error versus time from a start of an ion implantation, according to yet another exemplary aspect.

FIG. 6 illustrates a methodology for controlling a dosage of an ion implantation according to still another aspect.

### DETAILED DESCRIPTION

The present disclosure is directed generally toward a system, apparatus, and method for measuring a dosage of an ion implantation on a workpiece via a utilization of a calorimeter. Accordingly, the present invention will now be described with reference to the drawings, wherein like reference numerals may be used to refer to like elements throughout. It is to be understood that the description of these aspects are merely illustrative and that they should not be interpreted in a limiting sense. In the following description, for purposes of explanation, numerous specific details are set forth in order to provide a thorough understanding of the present invention. It will be evident to one skilled in the art, however, that the present invention may be practiced without these specific details. Further, the scope of the invention is not intended to be limited by the embodiments or examples described hereinafter with reference to the accompanying drawings, but is intended to be only limited by the appended claims and equivalents thereof.

It is also noted that the drawings are provided to give an illustration of some aspects of embodiments of the present disclosure and therefore are to be regarded as schematic only. In particular, the elements shown in the drawings are not necessary to scale with each other, and the placement of various elements in the drawings is chosen to provide a clear understanding of the respective embodiment and is not to be construed as necessarily being a representation of the actual relative locations of the various components in implementations according to an embodiment of the invention. Furthermore, the features of the various embodiments and examples described herein may be combined with each other unless specifically noted otherwise.

It is also to be understood that in the following description, any direct connection or coupling between functional blocks, devices, components, circuit elements or other physical or functional units shown in the drawings or described herein could also be implemented by an indirect connection or coupling. Furthermore, it is to be appreciated that functional blocks or units shown in the drawings may be implemented as separate features or circuits in one embodiment, and may also or alternatively be fully or partially implemented in a common feature or circuit in another embodiment. For example, several functional blocks may be implemented as software running on a common processor, such as a signal processor. It is further to be understood that any connection which is described as being wire-based in the following specification may also be implemented as a wireless communication, unless noted to the contrary.

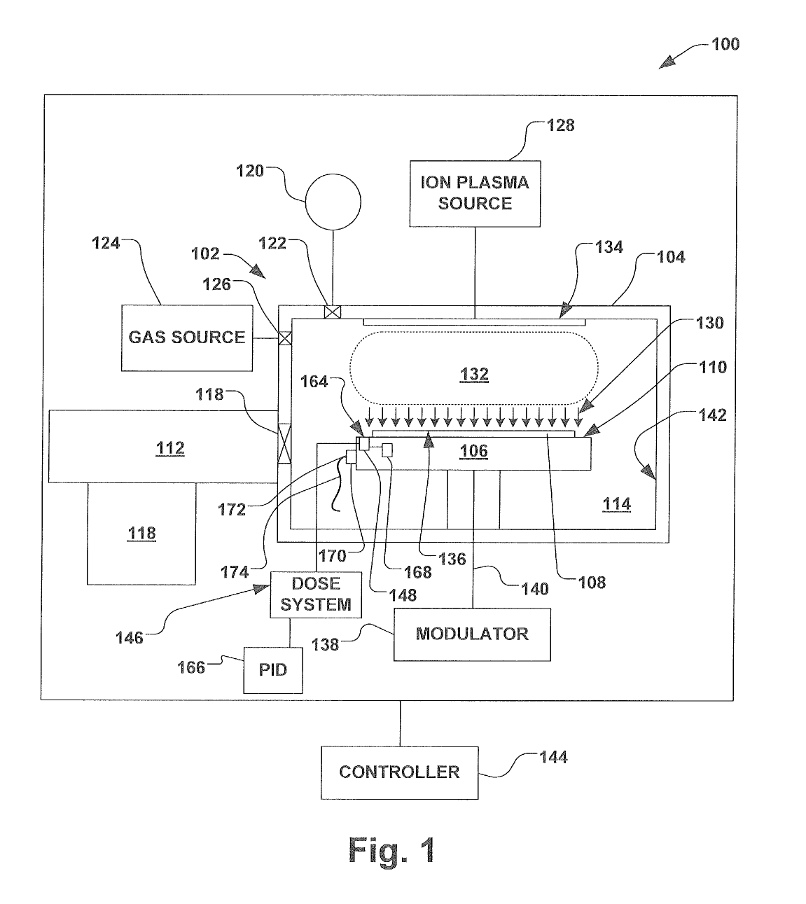

Referring now to the figures, FIG. 1 illustrates an exemplary ion implantation system 100. In particular, the present disclosure is directed toward a plasma immersion ion implantation (Pill) system 102, however, the present invention has utility in various other ion implantation systems 100, such as ion beam-based systems (not shown). As illustrated, the ion implantation system 100 comprises a process chamber 104, wherein a workpiece support 106 is generally positioned within process chamber. The workpiece support 106, for example, is configured to provide a surface for holding a workpiece 108, such as a semiconductor wafer (e.g., a silicon wafer). The workpiece support 106, for example, may comprise an electrostatic chuck or a mechanical clamping apparatus (not shown) configured to clamp the workpiece 108 about at its periphery to a support surface 110 of the workpiece support. The workpiece support 106, for example, is at least partially electrically conductive. The workpiece support 106 thus supports the workpiece 108, while further providing an electrical connection to the workpiece. It should be noted that while the workpiece support 106 is described in the present example as supporting one workpiece 108, various other configurations are also contemplated, such as a configuration of the workpiece support to concurrently support a plurality of workpieces.

A load lock 112 is operably coupled to the process chamber 104, wherein the load lock generally permits an internal environment 114 of the process chamber to be maintained at a predetermined pressure with respect to an external environment 116 (e.g., atmospheric pressure). The load lock 112 thus comprises a valve 118 configured to selectively permit a workpiece 108 to move into and out of the process chamber 104 while maintaining the predetermined pressure within the process chamber. A vacuum pump 120, for example, is further selectively fluidly coupled to the process chamber 104 via a vacuum valve 122, wherein the vacuum pump is configured to maintain the internal environment 114 at a reduced pressure. A gas source 124 is further selectively fluidly coupled to the process chamber 104 via a gas source valve 126, wherein the gas source is configured to supply an ionizable gas to the internal environment 114 of the process chamber.

In accordance with one example, an energy source 128 is provided above the workpiece support 106, wherein the energy source is configured to inject energy into the process chamber in order to ionize the gas from the gas source 124, therein producing a plasma of ions 130 in a plasma region 132 within the process chamber between the energy source and the workpiece support. The energy source 128, for example, is positioned within the process chamber 104, or alternatively, is provided along a wall 134 of the process chamber (e.g., a quartz plate, not shown), wherein an RF coil (not shown) operating at a predetermined frequency (e.g., between 2 MHz and 15 MHz) that transmits energy toward the workpiece 108 positioned on the workpiece support 106.

RF energy from the energy source 128 thus produces the plasma of ions 130 (also called an ion plasma) from gas molecules that are pumped into the process chamber 104 from the gas source 124. The pressure within the process chamber 104, for example, is maintained in the range of 0.2 to 5.0 millitorr. As one example, the gas source 124 provides nitrogen gas into the process chamber 104, wherein the nitrogen gas is ionized by the RF energy entering the process chamber via the energy source 128. Accordingly, the RF energy ionizes the gas molecules, therein producing the plasma of ions 130. It is noted that various other gases, techniques, and/or apparatus known for producing a plasma of ions 130 can be utilized, as all such gases, techniques, and/or apparatus are contemplated as falling within the scope of the present invention.

In accordance with the present disclosure, once the plasma of ions 130 is set up in the plasma region 132, the ions are accelerated into contact with the workpiece 108 positioned on the workpiece support 106. The workpiece support 106, for example, is at least partially electrically conductive. The plasma of ions 130, for example, are positively charged, such that an application of an electric field of suitable magnitude and direction in the plasma region 132 will generally cause the ions in the plasma to accelerate toward and impact a surface 136 of the workpiece 108. In accordance with one example, a pulse generator 138 (also called a modulator) supplies voltage pulses 140 (e.g., less than 10 kV) to the workpiece support 106, therein biasing workpiece support with respect to conductive inner walls 142 of the process chamber 104, thus inducing an electric field in the plasma region 132 and accelerating the plasma of ions 130 into the workpiece. The pulse generator 138, in one example, provides pulses in a range of 100 to 7000 volts, in 1 to 60 microseconds in duration and a pulse repetition rate up to 10 KHz. A controller 144 is further provided to control overall operation of the ion implantation system 100. For example, the controller 144 is configured to control the pulse generator 138, supply of gas from the gas source 124, movement of the workpiece 108 through the load lock 112, as well as other conditions associated with the ion implantation system 100.

It will be appreciated that while specific parameters for the pulse generator 138 and modulation of the voltage pulses 140 are provided as one example, other values and parameters may be utilized, and all such values and parameters are contemplated as falling within the scope of the present invention. The pulse voltage, for example, is selected to implant the positive ions to a desired depth in the workpiece 108. The number and duration of the pulses are further selected to provide a desired dose of impurity material into the workpiece 108. The current per pulse is also a function of pulse voltage, gas pressure and species, as well as any variable position of the electrodes. For example, the spacing between the energy source 128 and the workpiece support can be adjusted for various voltages.

Once the workpiece 108 is implanted with ions, the workpiece is removed from the process chamber 104 via the load lock 112, wherein further processing or fabrication of the workpiece can be performed. It is highly desirable, however, to tightly control the total energy implanted or deposited on the workpiece 108 during implantation, as resultant devices formed on the workpiece 108 are commonly dependent on proper doping during ion implantation. Accordingly, measurement of the total deposition energy during ion implantation is desirable in order to maintain proper manufacturing yields.

One method for determining total deposition energy comprises measuring a temperature of a predetermined thermal mass within the process chamber at the beginning of the ion implantation, followed by measuring the temperature of the thermal mass at the end of ion implantation, and then calculating the total energy that is deposited based on the temperature difference of the thermal mass. Such a methodology is moderately effective; however, environmental factors such as radiation losses from the thermal mass and conductive losses from electrodes (e.g., thermocouples, wiring, etc.) used for the temperature measurement can have deleterious effects on the resultant calculation. In low energy implants (e.g., deposits of energy of 5 Joules or less), a relatively low thermal mass is needed, and thermal resistance to surroundings needs to be substantially high.

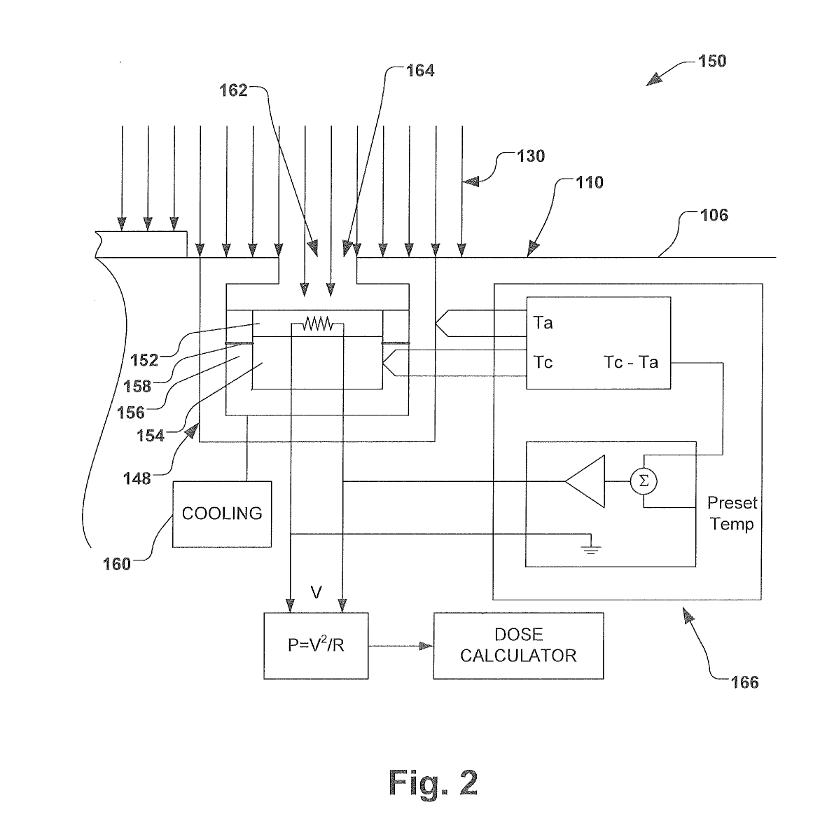

Rather than simply measuring temperature differences, however, the present disclosure utilizes calorimetry, therein integrating an amount of power needed to maintain a constant temperature into the determination of the total deposition energy of the ion implantation being performed. Thus, in accordance with the present disclosure, a dosimetry system 146 is provided, where a calorimeter 148 is provided within the process chamber 104, wherein the calorimeter is generally exposed to the plasma of ions 130 during the implantation. The dosimetry system 146 is illustrated as a schematic 150 in FIG. 2, wherein the calorimeter 148 comprises of a resistor 152 (e.g., a thick film resistor) formed or positioned over a ceramic substrate 154 (e.g., a 0.5 mm thick alumina substrate). The ceramic substrate 154 thus provides a thermal mass for absorbing energy from the plasma of ions 130 during the implantation. The ceramic substrate 154, for example, is comprised of alumina (aluminum oxide) or another suitable ceramic material. The calorimeter 148, for example, further comprises a ring 156 generally encircling the ceramic substrate 154, wherein one or more wires 158 (e.g., four wires radiating from the ceramic substrate and generally equidistantly spaced about the ceramic substrate) thermally couple the ceramic substrate to the ring. The one or more wires 158, for example, are comprised of copper or tungsten. The ring 156, for example, is operably coupled to a thermal cooling apparatus 160, wherein the thermal cooling apparatus is configured to generally remove heat from the ring. The thermal cooling apparatus 160, for example, comprises a fluid circulation system (e.g., chilled water) configured to remove heat from the ring 156.

Accordingly, the ceramic substrate 154 has a fixed conductive loss through the one or more wires 158 connecting the substrate to the ring 156 that surrounds the ceramic substrate. In accordance with one example, the calorimeter 148 comprises an aperture 162 positioned along the support surface 110 of the workpiece support 106, wherein the aperture defines an area 164 of the aperture of the calorimeter that is exposed to the plasma of ions 130.

The resistor 152 is thus configured to be heated with a predetermined power (e.g., approximately 1 watt) in order to maintain a predetermined constant temperature (e.g., 50 degrees C.) of the calorimeter 148 above ambient temperature. By heating the calorimeter 148 to a constant temperature differential above the ambient temperature of the internal environment 114 of FIG. 1, a thermal loss is provided to the internal environment, thus providing a constant power loss or “calorimeter constant”. If the power going into the calorimeter is measured during the implantation of ions, the integral of the calorimeter constant over that period of time minus the integral of the power going into the calorimeter 148 will provide the change in energy attributed to the ion implantation, itself.

In one example, the controller 144 further comprises a PID controller 166 configured to maintain the temperature of the calorimeter 148 at the predetermined constant. Thus, the power delivered to the calorimeter 148 is generally continuously monitored, and a calorimeter constant Kc is updated during periods between implants, thus correcting for variations in ambient temperatures. The calorimeter 148, for example, is powered via one or more batteries 168 and configured to communicate to the controller 144 via a non-electrically conductive signal transmitter 170 associated with therewith. Thus, the calorimeter 148 is controlled while generally preventing stray capacitance associated with the communication of the signal.

In one example, the non electrically-conductive signal transmitter 170 comprises a fiber optic signal transmitter 172, wherein the signal is communicated to the controller via a fiber optic cable 174. Alternatively, the non electrically-conductive signal transmitter 170 comprises a wireless transmitter (not shown), wherein the signal is communicated to the controller via the wireless transmitter to a wireless receiver (not shown) associated with the controller 144. The one or more batteries 168, for example, are configured to be recharged during one or more of a transfer or exchange of workpieces 108 and vacuum recovery periods, wherein the internal environment 114 is stabilized.

In accordance with another aspect of the present disclosure, the energy or Power P provided to the calorimeter 148 can be stated as:

$$P = \frac{{V}^{2}}{R} \qquad ( 1 )$$

where V=voltage provided to the calorimeter to maintain the constant predetermined temperature and R=resistance of the resistor 152. The measured energy into the calorimeter E_{c} during an implant from time t₀ to t₁ can be written as:

E_{c}=K_{C}(t₁−t₀)−∫ₜ_{₀}^{t}^{₁}Pdt (2)

where K_{C}=the calorimeter constant in watts.

The dosage of the implant Dose (e.g., expressed in ions/cm²) can be written as:

$$Dose = \frac{{E}_{c}}{{E}_{b} Aq} \qquad ( 3 )$$

where E_{b} is the ion beam or plasma energy (e.g., expressed in eV), A=the area of the aperture 164 of the calorimeter 148 (e.g., expressed in cm²), and q=the electron charge (e.g., 1.602×10⁻¹⁹ coulombs).

Thus, the Dose of the implantation of ions into the workpiece 108 can be finally calculated as:

$$Dose = \frac{{K}_{c} ( {t}_{1} - {t}_{0} ) - {\int }_{{t}_{0}}^{{t}_{1}} P d t}{{E}_{b} Aq} . \qquad ( 4 )$$

In accordance with one example, the temperature of the calorimeter 148 is controlled in a tight range (e.g., +/−0.1 degrees C.). In one example, since the PID controller 166 is employed to maintain a predetermined constant (e.g., 50 degrees C.) difference between the calorimeter 148 and its surroundings, environmental factors are automatically compensated for, such as day to day temperature changes. The temperature control equation for the PID controller is:

$${P}_{n} = {P}_{n - 1} + A [ 1 - \frac{{T}_{n}}{{T}_{s}} ] - B [ 1 - \frac{{T}_{n - 1}}{{T}_{s}} ] + C [ ( 1 - \frac{{T}_{n}}{{T}_{s}} ) - ( 1 - \frac{{T}_{n - 1}}{{T}_{s}} ) ] \qquad ( 5 )$$

where:

A=kᵢ+kₚ (6)

B=kₚ (7)

C=k_{d} (8)

and n=a loop counter indexed at a constant frequency.

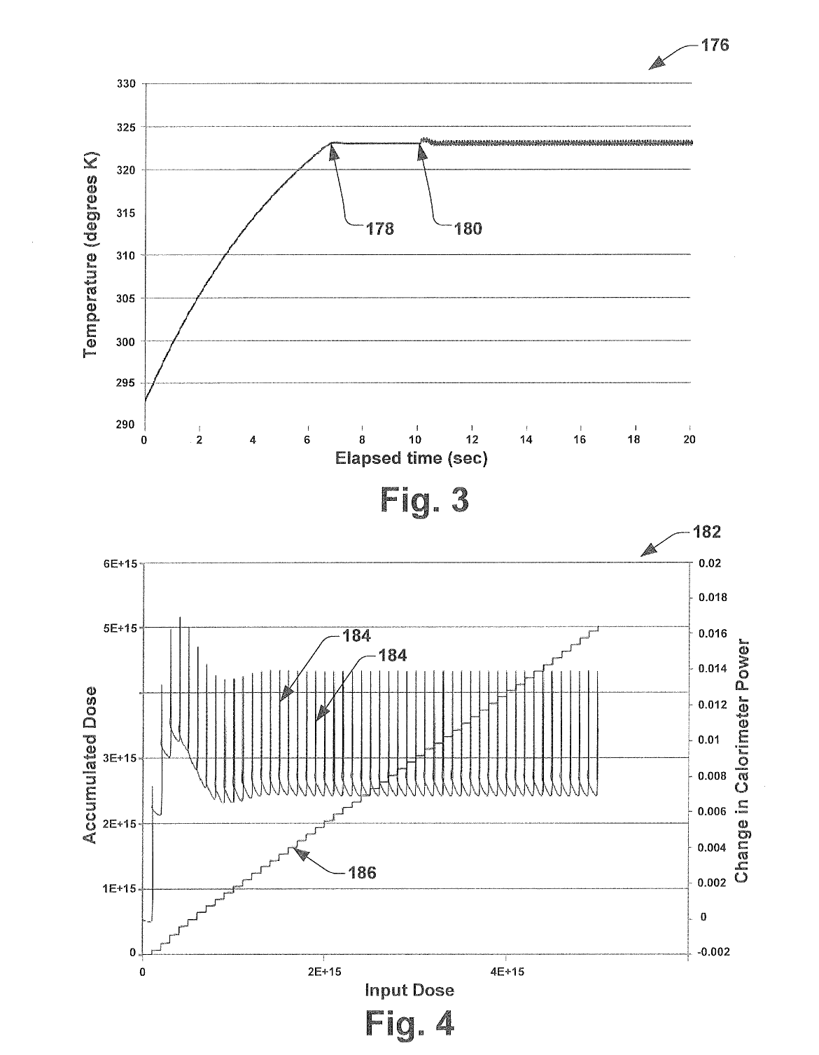

A model of the functionality of the dosimetry system 146 will now be described, wherein the thermal response characteristics of the calorimeter 148 are provided for an exemplary implantation of ions. For example, FIG. 3 illustrates a graph 176 of the temperature time response of the dosimetry control system 146 of FIG. 1 from the warm up of the ion implantation system 100 to a stabilization 178 of the PID control and a commencement 180 of the ion implantation. In the present example, the ion implantation was simulated using impulses of 1×10¹⁴ dose, with the impulses spaced 100 msec apart. The dose impulses thus create a disturbance in the control loop, causing the temperature to rise momentarily. In turn, the power supplied to the calorimeter 148 decreases proportionately. As shown in graph 182 of FIG. 4, the integrator of the PID control measures a drop in heater power 184 (e.g., also called power excursions) and converts it to an implant dose which can be seen in the staircase-like response 186 of accumulated implant dose shown in the graph. Accordingly, the accumulated implant dose Dₙ is used for end-point measurement to control the implantation of ions.

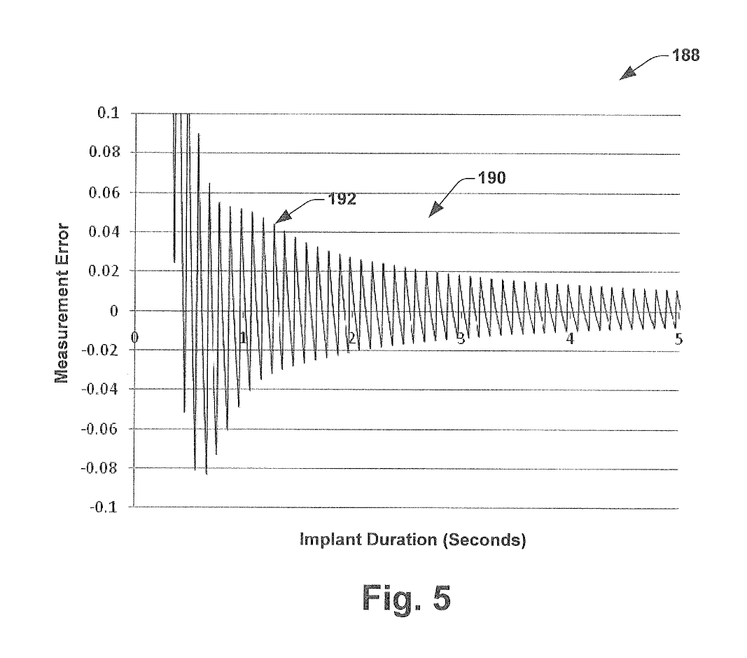

FIG. 5 is a graph 188 illustrating an error envelope 190 versus implant time, wherein a measurement error 192 is illustrated well within the desired operating range of the system. Each impulse of deposition energy to the calorimeter 148 of FIG. 1, for example, is reflected as a momentary drop in the applied heater power 184 shown in the graph 182 of FIG. 4. The PID controller 166 of FIG. 1, for example, responds relatively slowly to the impulse, thus allowing a momentary rise in calorimeter temperature and causing the input power to drop momentarily. The equation for the power excursions Qₙ in heater power 184 shown in FIG. 4 is:

Qₙ=(Kc−Pₙ)(tₙ−tₙ₋₁) (9).

The equation for the staircase ramp 186 in accumulated implant dose Dₙ is:

$${D}_{n} = \frac{{Q}_{n}}{{E}_{b} Aq} + {D}_{n - 1} . \qquad ( 10 )$$

Equations 9 and 10 thus represent the quantization of implant dose as a function of the calorimeter power difference.

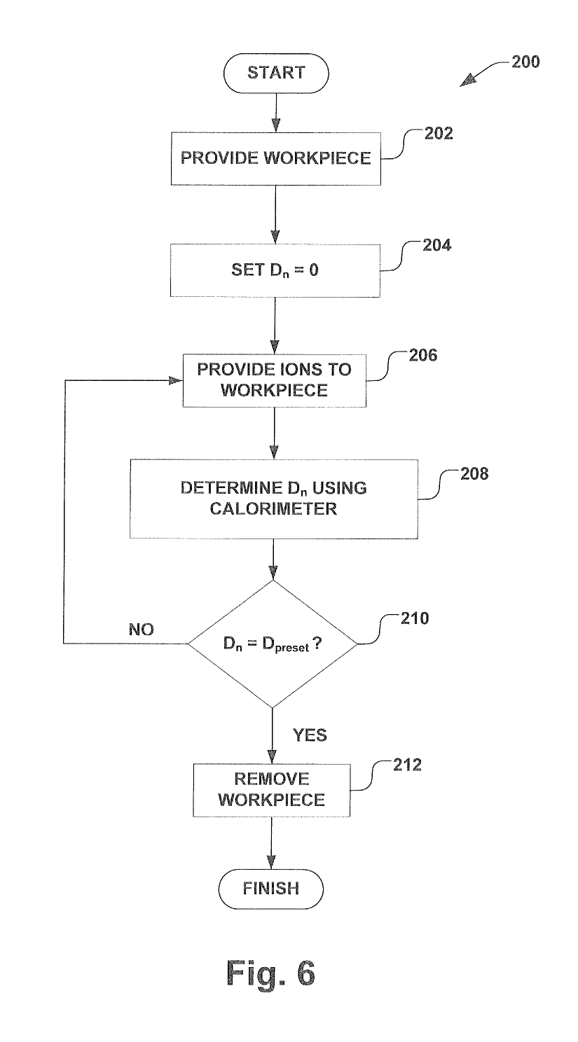

In accordance with another exemplary aspect of the invention, FIG. 6 illustrates an exemplary method 200 for measuring dosage during a plasma emersion ion implantation using a calorimeter. It should be noted that while exemplary methods are illustrated and described herein as a series of acts or events, it will be appreciated that the present invention is not limited by the illustrated ordering of such acts or events, as some steps may occur in different orders and/or concurrently with other steps apart from that shown and described herein, in accordance with the invention. In addition, not all illustrated steps may be required to implement a methodology in accordance with the present invention. Moreover, it will be appreciated that the methods may be implemented in association with the systems illustrated and described herein as well as in association with other systems not illustrated.

The method 200 of FIG. 6 begins at act 202, wherein a workpiece is provided on a workpiece support in a process chamber. The workpiece support, for example, comprises a calorimeter, such as the calorimeter 148 of the dosimetry system 146 of FIGS. 1 and 2. In act 204 of FIG. 6, a dosage Dₙ of implanted ions (also called a dose counter) is initially set to zero (Dₙ=D₀=0). A plasma of ions is provided in act 206, wherein an amount of ions are implanted into the workpiece for a period of time. In act 208, the dosage Dₙ (e.g., the accumulated amount of ions implanted into the workpiece) is determined via the calorimeter associated with the workpiece support and dosimetry system. For example, the dose Dₙ is updated in act 208 at a rate n that is equal to a clock frequency of the PID controller 166 of FIG. 1. In act 210, a determination is made regarding whether the dosage Dₙ has reached a predetermined preset dosage Dₚᵣₑₛₑₜ (also called a final implant dose). If the determination in act 210 is such that the preset dosage Dₚᵣₑₛₑₜ is achieved (e.g., Dₙ>=Dₚᵣₑₛₑₜ), the implantation is halted and the workpiece is removed from the process chamber in act 212. If the determination in act 210 is such that the preset dosage Dₚᵣₑₛₑₜ has not been achieved, the implantation continues by continuing to provide ions to the workpiece in act 206. It is noted that a residual error in the dosage Dₙ measurement in act 208 may be seen due to a time delay of the PID controller; however, the residual error is acceptably small, as evidenced in FIG. 5.

Although the invention has been shown and described with respect to a certain embodiment or embodiments, it should be noted that the above-described embodiments serve only as examples for implementations of some embodiments of the present invention, and the application of the present invention is not restricted to these embodiments. In particular regard to the various functions performed by the above described components (assemblies, devices, circuits, etc.), the terms (including a reference to a “means”) used to describe such components are intended to correspond, unless otherwise indicated, to any component which performs the specified function of the described component (i.e., that is functionally equivalent), even though not structurally equivalent to the disclosed structure which performs the function in the herein illustrated exemplary embodiments of the invention. In addition, while a particular feature of the invention may have been disclosed with respect to only one of several embodiments, such feature may be combined with one or more other features of the other embodiments as may be desired and advantageous for any given or particular application. Accordingly, the present invention is not to be limited to the above-described embodiments, but is intended to be limited only by the appended claims and equivalents thereof.

What is claimed is:

1. An ion implantation system for implanting ions into a workpiece, comprising:
a process chamber;
an energy source configured to produce a plasma of ions within the process chamber;
a workpiece support having a support surface configured to position the workpiece within an interior region of the process chamber, wherein workpiece support is configured to expose an implantation surface of the workpiece to the plasma of ions;
a calorimeter associated with the workpiece support; and
a controller configured to monitor a signal from the calorimeter and to control the implantation of ions into the workpiece based, at least in part, on the signal from the calorimeter.

2. The ion implantation system of claim 1, wherein the calorimeter comprises:
a ceramic substrate; and
a thick film resistor formed over the ceramic substrate.

3. The ion implantation system of claim 2, wherein the calorimeter further comprises
a ring generally encircling the ceramic substrate; and
one or more wires thermally coupling the ceramic substrate to the ring, therein providing a fixed conductive loss from the ceramic substrate to the ring.

4. The ion implantation system of claim 3, wherein the one or more wires comprises four or more wires equally spaced around the ceramic substrate.

5. The ion implantation system of claim 3, wherein the one or more wires are comprised of copper or tungsten.

6. The ion implantation system of claim 1, wherein the ceramic substrate comprises aluminum oxide.

7. The ion implantation system of claim 3, wherein the ring is operably coupled to a thermal cooling apparatus, wherein the thermal cooling apparatus is configured to remove heat from the ring.

8. The ion implantation system of claim 7, wherein the thermal cooling apparatus comprises a chilled water circulation system.

9. The ion implantation system of claim 3, wherein workpiece support comprises an aperture defined therein, wherein the ceramic substrate is exposed to the plasma of ions via the aperture.

10. The ion implantation system of claim 1, wherein the controller is configured to control a duration of the implantation of ions into the workpiece based on the signal from the calorimeter.

11. The ion implantation system of claim 1, wherein the calorimeter is imbedded in the workpiece support and exposed to the plasma of ions via an aperture.

12. The ion implantation system of claim 1, further comprising a non electrically-conductive signal transmitter associated with the calorimeter, wherein the signal from the calorimeter is communicated to the controller via the non electrically-conductive signal transmitter, therein generally preventing stray capacitance associated with the communication of the signal.

13. The ion implantation system of claim 12, wherein the non electrically-conductive signal transmitter comprises a fiber optic signal transmitter, wherein the signal is communicated to the controller via a fiber optic cable.

14. The ion implantation system of claim 12, wherein the non electrically-conductive signal transmitter comprises a wireless transmitter, wherein the signal is communicated to the controller via the wireless transmitter to a wireless receiver associated with the controller.

15. The ion implantation system of claim 1, wherein the calorimeter comprises a battery, wherein the calorimeter is generally powered by the battery.

16. The ion implantation system of claim 15, further comprising a recharging unit, wherein the recharging unit is selectively electrically connected to the battery of the calorimeter, and wherein the recharging unit is configured to recharge the battery when electrically connected thereto.

17. The ion implantation system of claim 1, further comprising a pulse generator in electrical communication with the workpiece support, wherein the pulse generator is configured to apply an electrical pulse to the support, therein attracting ions to the implantation surface of the workpiece and implanting ions into the workpiece.

18. The ion implantation system of claim 1, wherein the controller comprises a PID controller.

19. The ion implantation system of claim 1, wherein the workpiece support comprises a peripheral region disposed about a periphery of the support surface, wherein the calorimeter is positioned in the peripheral region of the workpiece support.

20. The ion implantation system of claim 1, wherein the workpiece support comprises an electrostatic chuck.

21. A method for controlling an implantation of ions into a workpiece, the method comprising:
providing the workpiece on a workpiece support in a process chamber;
inducing a plasma of ions in the process chamber for a period of time;
determining an amount of ions implanted into the workpiece via a calorimeter associated with the workpiece support; and
controlling the period of time based, at least in part, on the determined amount of ions implanted into the workpiece.
